(19) United States
(12) Patent Application Publication
(10) Pub. No.: US 2022/0154395 A1
(43) Pub. Date: May 19, 2022

(54) PRINTABLE MEDIUM INCLUDING A POLYURETHANE DISPERSION

(71) Applicant: HEWLETT-PACKARD DEVELOPMENT COMPANY, L.P., Spring, TX (US)

(72) Inventors: Xiaoqi ZHOU, San Diego, CA (US); Zhang-Lin ZHOU, San Diego, CA (US); Or BRANDSTEIN, San Diego, CA (US)

(73) Assignee: HEWLETT-PACKARD DEVELOPMENT COMPANY, L.P., Spring, TX (US)

(21) Appl. No.: 17/439,664

(22) PCT Filed: Oct. 3, 2019
(86) PCT No.: PCT/US2019/054382

§ 371 Date: Sep. 15, 2021

(51) Int. Cl. D06P 1/52; D06P 5/22; D06P 5/30; B41J 3/407; D06P 1/54

(52) U.S. Cl. CPC D06P 1/5285; D06P 5/22; D06P 1/54; B41J 3/4078; D06P 5/30

(57) ABSTRACT

Aspects of the present disclosure relate to a printable medium including a polyurethane dispersion. As an example, a printable medium may include a fabric base substrate, with an image-side and a back-side. A film-forming layer may be applied to the image-side of the fabric base substrate, including an anionic polyurethane dispersion having a reactive group on a backbone of the polyurethane dispersion and a reactive group on a capping unit of the polyurethane dispersion. An ink-receiving coating layer may be applied over the film-forming layer, including a crosslink agent.

### BACKGROUND

Inkjet printing technology has expanded its application to large format high-speed, commercial and industrial printing, in addition to home and office usage, because of its ability to produce economical, high quality, multi-colored prints. Inkjet printing technology has found various applications on different substrates including, for examples, cellulose paper, metal, plastic, fabric and the like. The substrate plays a key role in the overall image quality and permanence of the printed images.

Textile printing has various applications including the creation of signs, banners, artwork, apparel, wall coverings, window coverings, upholstery, pillows, blankets, flags, tote bags, etc. Textile is a flexible material consisting of a network of natural or artificial fibers which form yarn or thread. Textiles have an assortment of uses in the daily life, such as clothing, bags, baskets, upholstered furnishings, window shades, towels, coverings for tables, beds, and other flat surfaces, as well as in art. The coloration of textile includes generally dyeing and printing. The dyeing may apply colorant to the whole fabric network including yarn and thread. Printing on textile may place a specific design pattern in a special area under the design. Accordingly, inkjet printing, such as thermal inkjet, piezoelectric inkjet, and dye sublimation inkjet, among others, have been commercialized in the printing industry.

### DETAILED DESCRIPTION

When printing on fabric substrates, the specific nature of the fabric (e.g., textile) may impact the quality of the quality of the print. Some fabrics, for instance, can be highly absorptive, diminishing color characteristics, while some synthetic fabrics can be crystalline, decreasing aqueous ink absorption leading to ink bleed. These characteristics result in the image quality on fabric being relatively low. Additionally, black optical density, color gamut, and sharpness of the printed images are often poor compared to images printed on cellulose paper or other media types.

Some fabric has a very rough surface, and a very high amount of adhesive may be used to bond the printed image to the surface of the fabric. These characteristics may result in the image quality on fabric being compromised. Moreover, a reduction in image durability may result if the ink is printed on a rough and perhaps open fabric surface. However, softer fabric properties may be desired while maintaining colorant adherence and image quality.

A process referred to as pre-treatment may be applied during printing. Pre-treatment in general refers to or includes the application of a special formulated chemical composition to the textile substrate prior to printing. Specifically, in this disclosure, pre-treatment refers to applying a special formulated chemical composition by an analog method such as soaking, padding, rolling and spraying to the textile substrate.

In accordance with examples of the present disclosure, a printable medium may include a fabric base substrate, with an image-side and a back-side. A film-forming layer may be applied to the image-side of the fabric base substrate, including an anionic polyurethane dispersion having a reactive group on a backbone of the polyurethane dispersion and a reactive group on a capping unit of the polyurethane dispersion. An ink-receiving coating layer may be applied over the film-forming layer, including a crosslink agent.

In an additional example, a method for forming a printable medium may include providing a fabric base substrate, with an image-side and a back side. The method may include applying a film-forming layer on the image-side of the fabric base substrate. The film-forming layer may include an anionic polyurethane dispersion having a reactive group on a backbone of the polyurethane dispersion and a reactive group on a capping unit of the polyurethane dispersion. Yet further, the method may include applying an ink-receiving coating layer, on the image-side of the fabric base substrate, over the film-forming layer, including a crosslink agent. While examples herein describe printing on an image side as opposed to a back side of the fabric substrate, examples are not so limited. For instance, in some examples, the method may include applying the film-forming and ink-receiving layer on both sides of the fabric substrate, and applying an ink colorant to either and/or both sides of the fabric substrate.

In yet further examples, a printing method may include obtaining a printable medium, and applying an ink composition onto the printable medium to form a printed image. To obtain the printable medium, a film-forming layer may be applied to an image-side of a fabric base substrate with an image-side and a back-side in one example. Yet, in other examples, a film-forming layer may be applied on both sides of a fabric base substrate. The film-forming layer may include an anionic polyurethane dispersion having a reactive group on a backbone of the polyurethane dispersion and a reactive group on a capping unit of the polyurethane dispersion. Additionally, an ink-receiving coating layer may be applied on the image-side, over the film-forming layer, which includes a crosslink agent.

In examples of the present disclosure, pre-treatment on fabric textile may be accomplished by applying two layers of pre-treatment compositions. The first (film-forming) layer may comprise a polymeric latex which is able form a polymer film on the surface of the fabric textile with a glass transition temperature (Tg) less than 0 degrees Celsius (° C.). The pre-treatment may also include a second (ink-receiving coating) layer may be applied on the film-forming layer. The ink-receiving coating layer may include a reactive crosslinker which may react with the fabric substrate, the film-forming layer, and ink binders. This pre-treatment, including the application of the film-forming layer and the ink-receiving coating layer, increases image quality as measured by ink optical density on the surface of textile, and image durability as tested in color change after multiple washing with detergent. In various examples, the pre-treatment may be completed by analog methods such as soaking, padding, rolling and/or spraying. As used herein, the term “layer” refers to or includes a continuous filmed layer, and/or a film-forming polymer which generates a partial or semi-continuous overcoat on top of the fabric substrate.

In the following description various specific details are set forth to describe specific examples, with the understanding that other examples may be practiced without all the specific details given below and that features from figures/examples can be combined with features of another figure or example even though the combination is not explicitly shown or explicitly described as a combination. For ease of illustration, the same reference numerals may be used in different diagrams to refer to the same elements or additional instances of the same element.

Concentrations, amounts, and other numerical data may be expressed or presented in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. This same principle applies to ranges reciting a single numerical value. Furthermore, such an interpretation should apply regardless of the breadth of the range or the characteristics being described.

A printable medium including a polyurethane dispersion, in accordance with the present disclosure, may be accomplished by applying two pre-treatment compositions The first pre-treatment composition, also referred to as the film-forming layer, may contain dispersed latex particles to form a film on the substrate in a continuous overcoat, a partial overcoat, and/or a semi-continuous overcoat on the fabric substrate. The second pre-treatment composition, also referred to as the ink-receiving coating layer, may be applied to the surface modified by the first pre-treatment composition. The final printing by pigment inkjet may be completed on the pre-treated substrate.

The first pre-treatment composition may include a film-forming layer, applied to the image-side of the fabric base substrate, including an anionic polyurethane dispersion having a reactive group on a backbone of the polyurethane dispersion and a reactive group on a capping unit of the polyurethane dispersion. For instance, the first pre-treatment composition may include a polymeric latex which is able to form a film on the fabric textile surface upon drying without negatively impact softness of the fabric. The first pre-treatment composition may be a single polymeric compound and/or the mixture of the polymeric compounds. In a particular example, the first pre-treatment composition may include a single polymeric compound and/or a mixture of polymeric compounds in a range from about 1 wt % to about 20 wt %. In a more specific example, the first pre-treatment composition includes about 3 wt % of a single polymeric compound and/or a mixture of polymeric compounds. Additionally, the first pre-treatment composition may include a surfactant in a range from about 0.01 wt % to about 0.2 wt %. In a more specific example, the first pre-treatment composition includes about 0.03 wt % of surfactant.

The glass transition temperature (Tg) of the polymeric compound, or the glass transition temperature of the mixture may be in the range of about −15° C. to about 5° C. For instance, in some examples, the Tg may be and less than 5° C. As another specific example, the Tg may be less than 0° C. In yet a further specific example, the Tg may be less than −10° C. As used herein, by referring to a glass transition temperature (Tg) of the polymeric compounds in the mixture being less than 0° C., it is meant herein that the majority or nearly all polymeric compounds present in the mixture will have a glass transition temperature that is less than 0° C.

The glass transition temperature (Tg) of polymeric compounds may be measured using differential scanning calorimetry according to ASTM D6604: Standard Practice for Glass Transition Temperatures of Hydrocarbon Resins by Differential Scanning calorimetry. Differential scanning calorimetry can be used to measure the heat capacity of the polymer across a range of temperatures. The heat capacity can jump over a range of temperatures around the glass transition temperature. The glass transition temperature itself can be defined as the temperature where the heat capacity is halfway between the initial heat capacity at the beginning of the jump and the final heat capacity at the end of the jump.

Additionally, the film-forming layer may include a polymeric compound which is selected from the group consisting of polyurethane and polyurethane derivative such as vinyl-urethane, acrylic urethane, polyurethane-acrylic, polyether polyurethane, polyester polyurethane, polycaprolactam polyurethane, polyether polyurethane, and combinations thereof.

In some specific examples, the polymeric compound may include a polyurethane polymer. The polyurethane polymer can be formed by reacting an isocyanate with a polyol. Example isocyanates used to form the polyurethane polymer can include, for example, toluene di-isocyanate, 1,6-hexamethylenediisocyanate, diphenylmethanedi-isocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyl-triphenyl-methane-tetra-isocyanate, triphenyl-methane-tri-isocyanate, tris(iso-cyanate-phenyl)thiophosphate, and combinations thereof. Commercially available isocyanates can include Rhodocoat® WT 2102 (available from Rhodia AG), Basonat® LR 8878 (available from BASF), Desmodur® DA, and Bayhydur® 3100 (Desmodur® and Bayhydur® are available from Bayer AG). Example polyols used to form the polyurethane polymer can include 1,4-butanediol, 1,3-propanediol, 1,2-ethanediol, 1,2-propanediol, 1,6-hexanediol, 2-methyl-1,3-propanediol, 2,2-dimethyl-1,3-propanediol, neopentyl glycol, cyclo-hexane-dimethanol, 1,2,3-propanetriol, 2-ethyl-2-hydroxymethyl-1,3-propanediol, and combinations thereof.

In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities (—NCO) per molecule and at least one isocyanate reactive group (e.g., such as a polyol having at least two hydroxyl or amine groups). Example polyisocyanates can include diisocyanate monomers and oligomers. The self-crosslinked polyurethane polymer can also be formed by reacting an isocyanate with a polyol, where both isocyanates and polyols have an average of less than three end functional groups per molecule so that the polymeric network is based on a linear polymeric chain structure. In one example, the polyurethane can be prepared with a NCO/OH ratio ranging from about 1.2 to about 2.2. In another example, the polyurethane can be prepared with a NCO/OH ratio ranging from about 1.4 to about 2.0. In yet another example, the polyurethane can be prepared using an NCO/OH ratio ranging from about 1.6 to about 1.8.

In one example, the polyurethane may be a reactive polyurethane dispersion (PUD). The reactive PUD may include a single isocyanate or a blend of two different isocyanates, reactive acrylate functional groups introduced in either the backbone of the polyurethane or the capping units of the polyurethane, and in some instances, stabilization groups such as carboxylate or sulfonate groups introduced in the capping units. In various examples, acid stabilization groups are not introduced in the backbone of the polyurethane. The general structure of the reactive PUD is illustrated in the following formula (1):

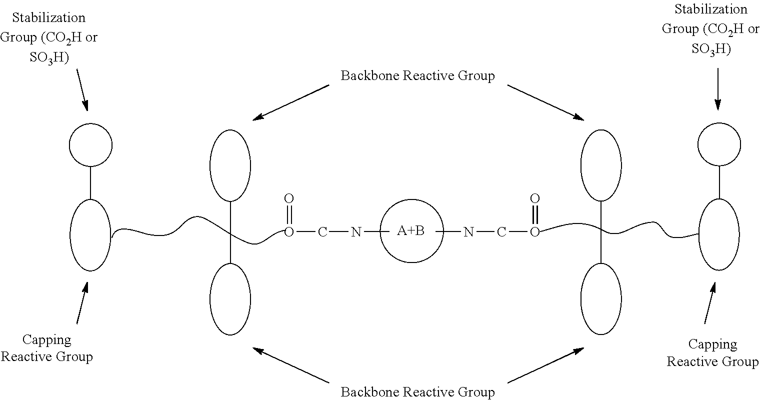

The stabilization group may include either carboxylate or sulfonate groups. Additionally, the capping reactive groups may include acrylate, methacrylate groups, HEAA, styrene-based mono-alcohol, allyl-based mono-alcohol and/or amine based capping groups. An example styrene-based capping reactive group includes GenFlo® 3000, commercially available from Omnova Solutions, Inc. As illustrated above, A+B refers to either one single isocyanate or a blend of a plurality of isocyanates.

In the example illustrated above, the following components are included:

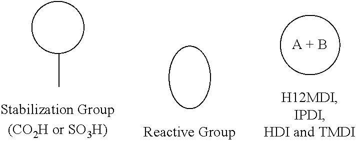

In one example, backbone reactive groups such as acrylate or methacrylate may be introduced onto the backbone of polyurethane dispersion by using reactive diols such as Bisphenol A glycerolate (1 glycerol/phenol) diacrylate (BGDA) available from Sigma-Aldrich Chemical Company and an aliphatic alkyl epoxy acrylate (PEA). Some commercially available examples of the aliphatic alkyl epoxy acrylate include MIRAMER® PE-230 (aliphatic alkyl epoxy acrylate) (available from Miwon Chemical). Examples of BGDA (formula 2) and PE-230 (formula 3), are illustrated below:

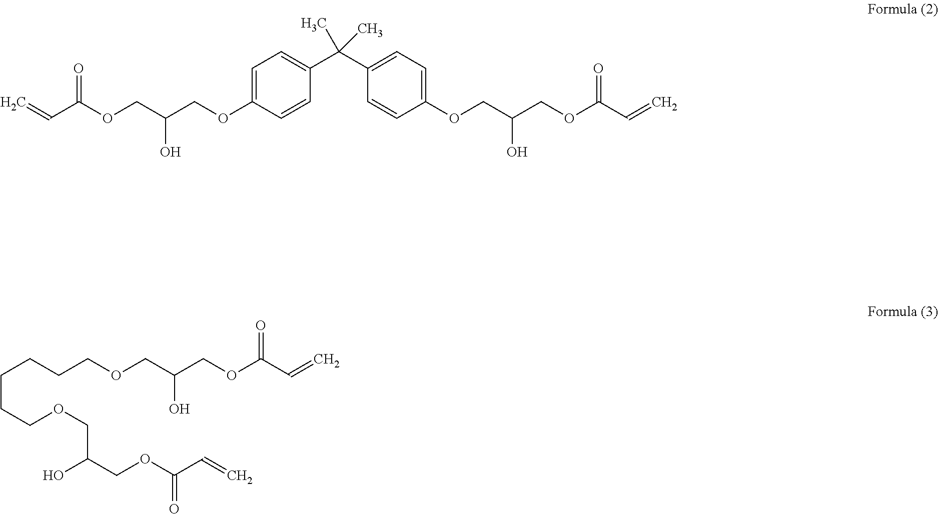 [SMILES: C=CC(=O)OCC(O)COc1ccc(C(C)(C)c2ccc(OCC(O)COC(=O)C=C)cc2)cc1 ; C=CC(=O)OCC(O)COCCCCCCOCC(O)COC(=O)C=C]

The reactive groups such as acrylate, methacrylate, acrylamide or allyl groups may also be introduced onto the end of the polyurethane dispersions by capping or terminating groups such as hydroxyethyl acrylate (HEA) (formula 4), hydroxylethylacrylamide (HEAA) (formula 5), glycerol 1,3-dimethacrylate (HPBMA) (formula 6), pentaerythritol triacylate (PETA) (formula 7), glycerol 1,3-diallylether (GDAE) (formula 8), as illustrated below:

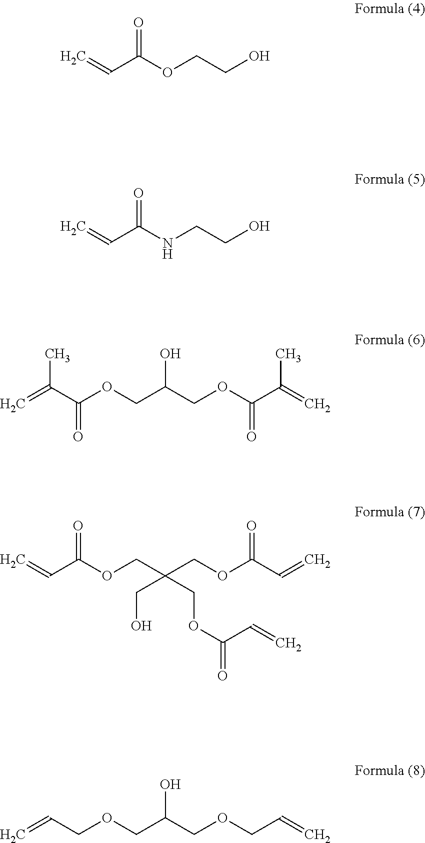

To make the reactive polyurethane dispersion dispersible in water, the stabilization functional groups such as —CO₂H or —SO₃H may also be grafted onto polyurethane dispersions by using the capping groups such as amino acids, taurine, 3-(cyclohexylamino)-1-propanesulfonic acid (CAPS), 2-(cyclohexylamino)ethansesullfonic acid (CHES).

Other examples of the polyurethane polymeric compound that can be used include vinyl-urethane, acrylic urethane, polyurethane-acrylic, polyether polyurethane, polyester polyurethane, polycaprolactam polyurethane, or polyether polyurethane. Any of these examples may be aliphatic or aromatic. For example, the polyurethane may include aromatic polyether polyurethanes, aliphatic polyether polyurethanes, aromatic polyester polyurethanes, aliphatic polyester polyurethanes, aromatic polycaprolactam polyurethanes, or aliphatic polycaprolactam polyurethanes.

In some examples, the polymeric compound that can be used include vinyl-urethane, acrylic urethane, polyurethane-acrylic is formed by using vinyl-urethane hybrid copolymers or acrylic-urethane hybrid copolymers. In yet some other examples, the polymeric network(s) includes an aliphatic polyurethane-acrylic hybrid polymer. Representative commercially available examples of the chemicals which can form an acrylic-urethane polymeric network include NeoPac®R-9000, R-9699 and R-9030 (from Zeneca Resins) or HYRBIDUR™ 570 (from Air Products and Chemicals). In still another example, the polymeric network includes an acrylic-polyester-polyurethane polymer, such as Sancure® AU 4010 (from Lubrizol Inc.).

In some examples, any example of the polymeric compound can include a polyether polyurethane. Representative commercially available examples of the chemicals which can form a polyether-urethane polymeric network include Alberdingkusa® U 205, Alberdingkusa® U 410, and Alberdingkusa® U 400N (all from Alberdingk Boley Inc.), or Sancure®861, Sancure® 878, Sancure® 2310, Sancure® 2710, Sancure® 2715, or Avalure® UR445 (equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer” (all from Lubrizol Inc.).

In other examples, any example of the polymeric compound can include a polyester polyurethane. Representative commercially available examples of the chemicals which can form a polyester-urethane polymeric network include Alberdingkusa® 801, Alberdingkusa® u 910, Alberdingkusa® u 9380, Alberdingk® u 2101 and Alberdingk® u 420 (all from Alberdingk Boley Inc.), or Sancure® 815, Sancure® 825, Sancure® 835, Sancure® 843c, Sancure® 898, Sancure® 899, Sancure® 1301, Sancure® 1511, Sancure® 2026c, Sancure® 2255, and Sancure® 2310 (all from Lubrizol, Inc.). In still other examples, any example of the polymeric compound can include a polycarbonate polyurethane. Examples of polycarbonate polyurethanes include Alberdingkusa® U 933 and Alberdingkusa® U 915 (all from Alberdingk Boley Inc.).

Other functional additives such as surfactant, humectants, pH control agents and rheological control agents can be also included into the film-forming layer. An example surfactant that may be added includes BYK® Dynewet 800, commercially available from Byk Inc.

An ink-receiving coating layer may be applied on top of the film-forming layer. The ink-receiving coating layer, before dried, may be in a status of an aqueous solution. After applied using an analog method such as padding, soaking, rolling and/or spray methods, the composition may be dried and aqueous solvents such as water may be removed, leaving the chemicals in the composition spontaneously on the outmost surface of the printing media surface. The ink-receiving coating layer may further include a crosslink agent. A crosslink agent refers to or includes a chemical with functional groups capable of forming a crosslinking reaction with other reactive groups such as amine, carboxyl, hydroxyl, and thiol on the surface of the film-forming layer, of the textile substrate, and binders of pigmented inks upon certain condition such as heating to a temperature between about 50° C. and about 200° C. The crosslink agent may be compatible with solvent, for instance with an aqueous solvent like water to form a uniform solution without phase separation or gelling. In various examples, the ink-receiving coating layer includes a crosslink agent in a range from about 0.5 wt % to about 10 wt %, and a surfactant in a range from about 0.0025 wt % to about 0.05 wt %. In a more particular example, the ink-receiving coating layer includes about 1 wt % of a crosslink agent and about 0.005 wt % of a surfactant.

In one example, the crosslink agent is a heterocyclic ammonium salt. Additionally, the heterocyclic salt may be a polymeric salt consisting of four membered heterocyclic rings containing a quaternary ammonium as shown in the structure below:

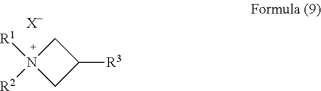

where R3 is hydroxyl, or alternatively, are carboxy, acetoxy, alkoxy, amino and alkyl, for example at the 3′-position and R1 and R2 are end groups connecting 1,1′-nitrogen position. When R3 is a hydroxyl group, the structure may be referred to as an azetidinium salt. The heterocyclic salt may be formed from the reaction of either a primary amine or a secondary amine with epichlorohydrin by a two-step reaction as shown in equations 1 and 2, below:

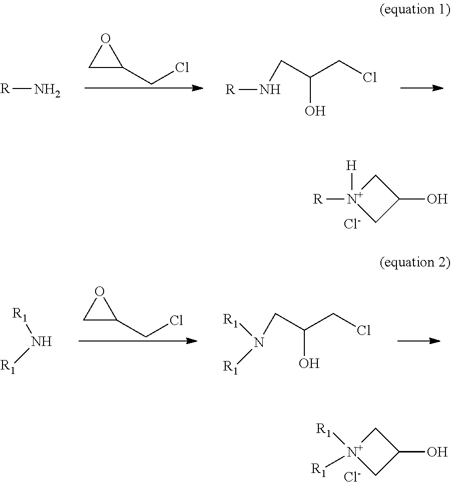

The nitrogen has a positive charge with halide such as chlorine as a counter ion, and the ring structure makes the composition reactive under even mild conditions with multiple function groups such as carboxylates, amines, phenols, phosphorus nucleophiles such as equations shown below:

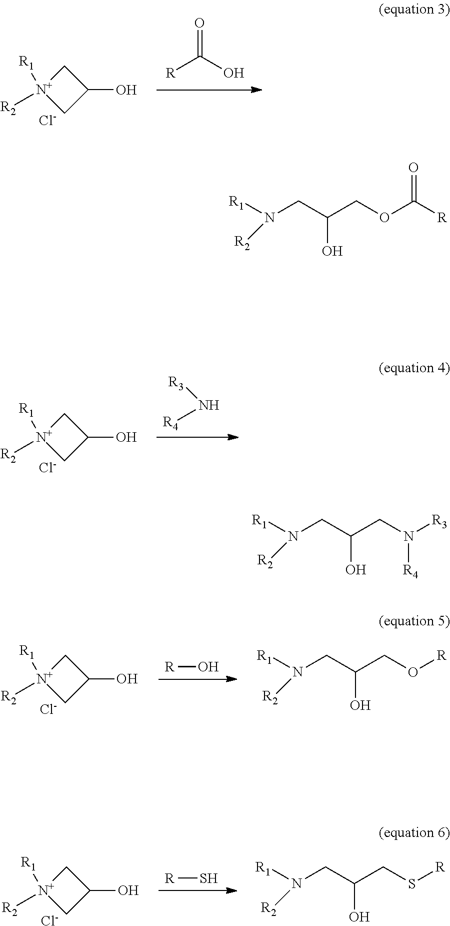

In other example, the crosslink agent in the ink-receiving coating layer, may be a diallylazetidium salt (formula 10 below), or a bis(2-methoxyethyl)azetidinium salt (formula 11 below):

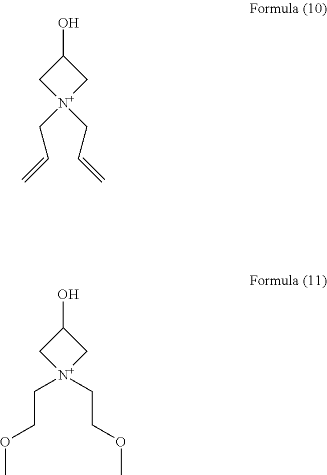

Yet further, the crosslink agent may be a nonylpropylazetidinium salt (formula 12), a undecylmethylazetidinium salt (formula 13) and/or a nonylpropargylazetidinium salt (formula 14) with the structure illustrated in the following figures. They can be used a single crosslink agent or combinations.

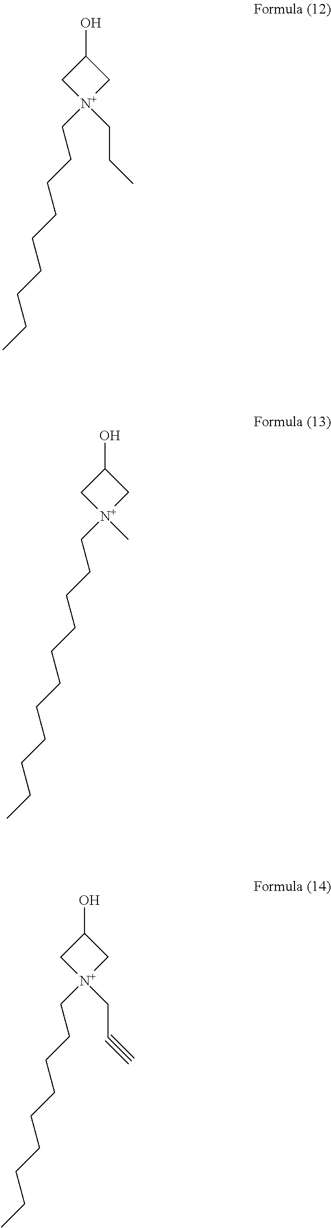

An example commercially available self-crosslinking binder includes: TEXICRYL™ 13-216 (Scott Bader).

The following are additional examples of azetidinium salts based cross-linker agents that can be made from the reaction of a polyetheramine with epichlorohydrin (equations 7-13). The polyetheramine is commercially available, for example, with trade name Jeffamine® from Huntsman Corporation LLC such as Jeffamine® 900, Jeffamine® M, Jeffamine® XTJ, Jeffamine® JA-T-403, and Jeffamine® T-403 triacryloylamide (JA-T-403 TA).

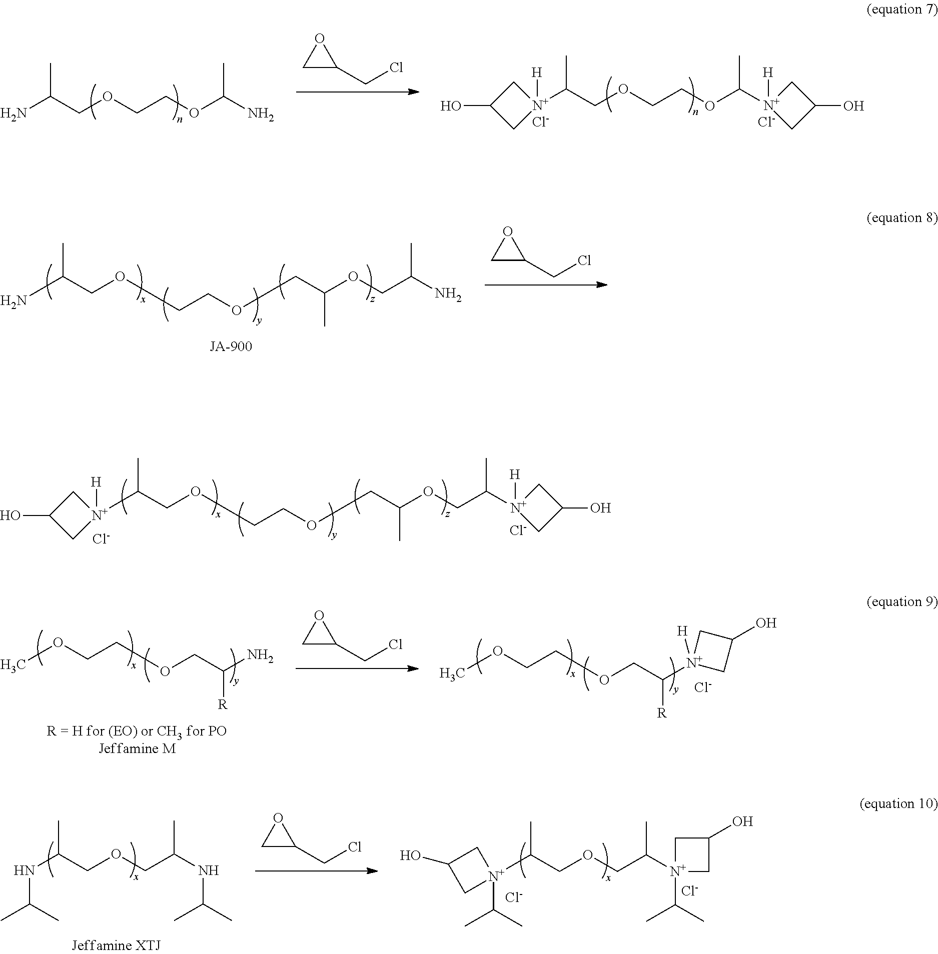

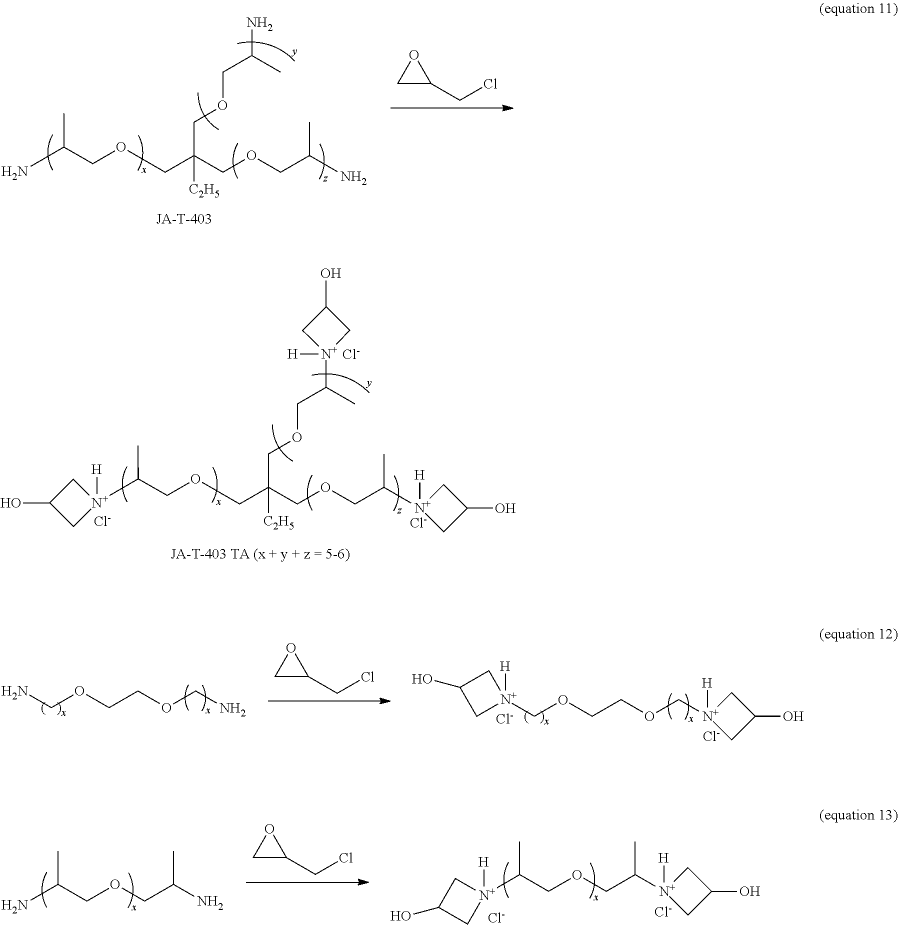

In other examples crosslink agent may be polymeric heterocyclic salt as illustrated in formula 15. Further, the polymeric heterocyclic salt may include four membered heterocyclic rings with a quaternary ammonium as shown in the formula 15 and formula 16 below:

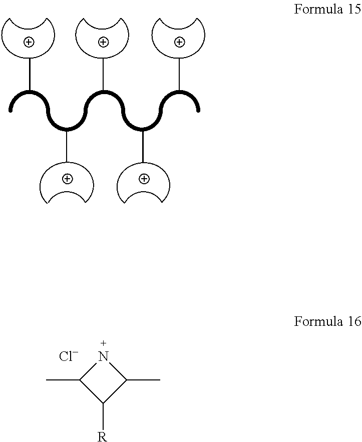

where R is hydroxyl, carboxy, acetoxy, alkoxy or amino and alkyl at the 3′-position and 1,1′-nitrogen position is connected polymeric backbone in long chain such as a polyamide chain and/or a polyalkylenepolyamine chain.

In some examples, the polymeric oligomer to make the polymeric heterocyclic salt may be made of polyamidoamine as illustrated in equation 14 below:

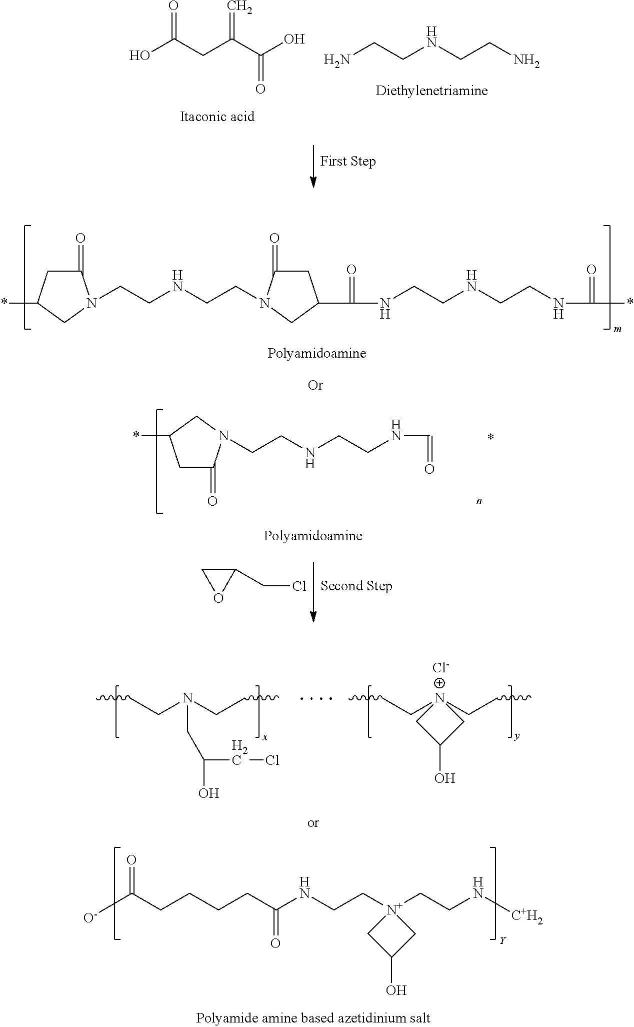

The backbone polymeric structure in this disclosure may include, but is not limited to, polyethylene imine, polyamidoamine, the polyamidoaminester, or a polyester backbone with pendant secondary amine groups.

In various examples, the polymeric dispersion may be both cationic (due to the quaternary ammonium group) and reactive due to the Bayer strain (angel strain) in the four membered ring. The presence of these cationic functional polymers may assist the binding of anionically dispersed pigmented ink colorant, where these reactive function groups can react with the nucleophilic groups of the printing media surface and improve the adhesion via chemical bonding.

The polymeric heterocyclic salt in various examples is commercially available, for example, with trade name Beetle® PT746 from BIP (Oldbury) Ltd, Polycup™ serial from Solenis, Inc such as Polycup™ 8210, Polycup™ 9200, Polycup™ 7535, Polycup™ 7360A, Polycup™ 2000, Polycup™ 172 and Polycup™ 9700.

The textile substrate, as used herein, may be made of any kind of natural and synthetic fabric. In one example, the textile substrate is a cotton textile, which includes, but is not limited to, regular plant cotton, organic cotton, pima cotton, supima cotton and slub cotton. In other examples, the textile substrate may be made of other textile substrates such as Linen (from the flax plant and has a textured weave), and/or Lycra®. Further, in other examples, the textile substrate may be a synthetical textile such as polyester, or man-made fiber created from natural trees, cotton, and plants such as rayon. Further in other examples, the textile substrate may be a mixture of both natural fabrics and synthetic fabrics such as polyester and cotton 50%/50% blended fabric textile, or tri-blends made up of three different types of material which may include polyester, cotton and rayon.

In some examples, the textile substrate may be selected from the same yarn of materials such as cotton but have different structures due to the weaving method. For instance, the textile substrate may a include plain weave fabric, an end-on-end weave fabric, a voile weave fabric, a twill weave fabric, and/or an Oxford weave fabric.

Various methods may be used to apply the pre-treatment compositions to the textile substrate. In some examples, a variety of spray coating methods may be used with the present embodiment. In one example, the fabric substrate may be passed under an adjustable spray nozzle. The adjustable spray nozzle may be configured to alter the rate at which the pre-treatment solution is sprayed onto the fabric substrate. By adjusting factors such as the rate at which the fabric substrate is passed under the nozzle, the rate at which the composite solution is sprayed on the base paper, the distance of the fabric substrate from the nozzle, the spraying profile of the nozzle, and the concentration of the pre-treatment solution, a layer of pre-treatment composition with desired attributes may be deposited on the fabric substrate.

The application of the pre-treatment composition to the textile substrate may be carried out using padding procedures. The fabric substrate can be soaked in a bath and the excess can be rolled out. More specifically, impregnated fabric substrates (prepared by bath, spraying, dipping, etc.) can be passed through padding nip rolls under pressure. The impregnated fabric, after nip rolling, can then be dried under heat at any functional time which is controlled by machine speed with peak fabric web temperature. In some examples, pressure can be applied to the fabric substrate after impregnating the fabric base substrate with the pre-treatment composition. In some other examples, the surface treatment may be accomplished in a pressure padding operation. During such operation, the fabric base substrate is firstly dipped into a pan containing treatment coating composition and is then passed through the gap of padding rolls. The padding rolls (a pair of two soft rubber rolls or a metal chromic metal hard roll and a tough-rubber synthetic soft roll for instance), apply the pressure to composite-wetted textile material so that composite amount can be accurately controlled. In some examples, the pressure, that is applied, is between about 10 and about 150 PSI or, in some other examples, is between about 30 to about 70 PSI. Each of the film-forming layer and the ink-receiving coating layer may be applied with a coat-weight range from about 0.1 grams per square meter (GSM) to about 20 GSM. Example coat weights for the film-forming layer and the ink-receiving coating layer are discussed in Table 2, below.

Further, in non-limiting examples, the pre-treatment may be accomplished in a soaker with a turning wheel on the bottom of the soaker. In such examples, the pretreatment composition is added into the soaker with mild agitation by a turning wheel. The fabric materials to be treated upon are then immersed into the pre-treatment solution and soaked with gentle agitation by a turning wheel, and the excessive pre-treatment solution may be removed by pressing the fabric web through the nip of padding rolls.

The film-forming pre-treatment composition may be applied on the textile substrate first, followed with the ink-receiving coating layer. The finished pre-treated textile may be immediately printed upon without completely drying out. Additionally, and/or alternatively, the textile may be dried by any heated device such as an infrared (IR) dryer, hot air dryer and/or a box drier, among other examples. The dryer can be a single unit or could be in a serial of three to seven units so that a temperature profile can be created with initial higher temperature, to remove excessive water, and mild temperature in end units, to ensure completely drying with a final moisture level of less than 1-5% for example. The peak dryer temperature can be programmed into a profile with higher temperature at a begging of the drying when wet moisture is high and reduced to lower temperature when web becoming dry. The dryer temperature may be controlled to a temperature of less than about 100° C. In some examples, the operation speed of the padding/drying line is 50 yards per minute. In various examples, heat may be applied to the pre-treated medium, in a range from about 50° C. to 120° C. for about 5 seconds to about 3 minutes.

### Examples

The following illustrates examples of the compositions and related aspects described in the present disclosure. Thus, these examples should not be considered to restrict the present disclosure, but are merely in place to teach how to make examples of compositions of the present disclosure.

A reactive film-forming polyurethane for the first pre-treatment was synthesized using the following procedure. 22.506 g of g of BGDA (Formula 2), 0.225 g of 4-methoxyphenol (MEHQ), 36.553 g of 4,4′-methylenebis(cyclohexyl isocyanate) (H12MDI) (Formula 1) and 30 g of acetone were mixed in a 500 ml of 4-neck round bottom flask. A mechanical stirrer with a glass rod and a Teflon blade was attached. A condenser was attached. The flask was immersed in a constant temperature bath at 60° C. The system was kept under drying tube. 3 drops of Dibutyltin dilaurate (DBTDL) was added to initiate the polymerization. Polymerization was continued for 3 hours at 60° C. 0.5 g samples was withdrawn for % NCO titration to confirm the reaction. 26.500 g of HPBMA (Formula 6), 0.265 g of Mequinol (MEHQ), and 19 g of acetone were mixed in a beaker and added to the reactor over 30 sec. 9 g of acetone was used to rinse off the residual monomers on the beaker and added to the reactor. The polymerization was continued 3 hours at 60° C. The polymerization temperature was reduced to 40° C. 14.441 g of 2-(cyclohexylamino)ethansesullfonic acid (CHES), 5.852 g of 50% sodium hydroxide (NaOH), and 38.102 g of deionized (DI) water were mixed in a beaker until CHES was completely dissolved. The CHES solution was added to the pre-polymer solution at 40° C. with vigorous stirring over 1-3 minutes. The solution became viscous and slight hazy. The solution was stirred for 30 minutes at 40° C. The mixture became clear and viscous after 15-20 minutes at 40° C. 187.6144 g of cold deionized water was added to the polymer mixture in a 4-neck round bottom flask over 1-3 minutes with good agitation to form the PUD dispersion. The agitation was continued for 60 minutes at 40° C. The PUD dispersion was filtered through a 400-mesh stainless sieve. Acetone was removed with a rotavap at 50° C. (adding 2 drops (20 mg) of BYK-011 de-foaming agent if there was a lot of foaming). The final PUD dispersion was filtered through fiber glass filter paper. Particle size as measured by Malvern Zetasizer was 21.93 nm. The pH was 7.0, and the solid content was 27.22%.

The formulation for the film-forming layer and the ink-receiving coating layer is presented in Table 1, below:

TABLE 1

| | | | Pretreatment formulation (parts by dry | | | |
|---|---|---|---|---|---|---|
| Chemicals | | | weight) | | | |
| Chemical ID | Description | Supplier | T1 | T2 | T3 | T4 |
| Reactive | Formula 1 | Not Applicable | 100 | | | |
| Polyurethane | | | | | | |
| Texicryl ™ 13- | film-forming | Scott Bader Co | | 100 | | |
| 216 | polyacrylic | | | | | |
| GenFlo ® 3000 | Film-forming | Omnova | | | 100 | |
| | polymer | Solutions | | | | |
| | (Carboxylated | | | | | |
| | styrene budatiene | | | | | |
| | copolymer) | | | | | |
| Polycup ™ | Reactive cross- | Solenis Ltd | | | | 100 |
| | linker | | | | | |
| BYK ®Dynwet | Surfactant | BYK Inc | 1 | 1 | 1 | 0.5 |
| 800 | | | | | | |
| DI Water | | | adjust to | adjust to | adjust | adjust |
| | | | 3% | 3% | to 3% | to 1% |
| | | | solids | solids | solids | solids |
| | | | content | content | content | content |

Table 1 above illustrates four sets of different pre-treatments for the same fabrics. The first pre-treatment composition (T1) included 100 parts of the reactive polyurethane, as illustrated in Formula 1 above. The second pre-treatment composition (T2) included 100 parts of a film-forming polyacrylic such as Texicryl™ 13-216. The third pre-treatment composition (T3) included 100 parts of a film-forming polymer (carboxylated styrene budatiene copolymer) such as GenFlo® 3000. The fourth pre-treatment (T4) T4 included a reactive cross-linker such as Polycup™. Each of the pre-treatment compositions T2, T2, T3, and T4, included 1 part of surfactant such as BYK®Dynwet 800, and DI water to adjust the pre-treatment composition to a 3% solid content.

Using the pre-treatments formulated as discussed in Table 1, five separate experiments were conducted, as discussed in Table 2, below:

| | Pretreatment (formulation/pick-up | |
|---|---|---|
| | in grams per square meter) | |
| | First | Second |
| Example ID | Pretreatment | Pretreatment |
| Exp. 1 | T1/3 | T4/1 |
| Exp. 2 | T2/3 | T4/1 |
| Exp. 3 | T3/3 | T4/1 |
| Exp. 4 | | T4/1 |
| (comparative) | | |
| Exp. 5 | T3/3 | |
| (comparative) | | |

Table 2 above illustrates five sets of different pre-treatments for the same fabrics with either two-layer pre-treatments or single layer pre-treatment with the coating weight. In the first experiment (Exp. 1), the fabrics were first coated with 3 GSM (grams per square meter) of pre-treatment formulation T1 (discussed in Table 1), then coated with 1 GSM of pre-treatment formulation T4 (discussed in Table 1). In the second experiment (Exp. 2), the fabrics were first coated with 3 GSM of pre-treatment formulation T2 (discussed in Table 1), then coated with 1 GSM of pre-treatment formulation T4 (discussed in Table 1). In the third experiment (Exp. 3), the fabrics were first coated with 3 GSM of pre-treatment formulation T3 (discussed in Table 1), then coated with 1 GSM of pre-treatment formulation T4 (discussed in Table 1). In the fourth experiment (Exp. 4), the fabrics were only coated with 1 GSM of pre-treatment formulation T4 (discussed in Table 1). In the fifth experiment (Exp. 5), the fabrics were only coated with 3 GSM of pre-treatment formulation T3 (discussed in Table 1).

The printing image quality and the image durability results were collected after pre-treatment. The results of the printing image quality and the image durability tests are presented in Table 3 below.

TABLE 3

| | Initial OD | | ΔE after 5 washing | |
|---|---|---|---|---|
| | (before washing) | | cycle with detergent | |
| Example ID | Black | Cyan | Black | Cyan |
| Exp. 1 | 1.17 | NA | 0 | NA |
| Exp. 2 | 1.24 | 1.21 | 4.6 | 4.1 |
| Exp. 3 | 1.20 | 1.22 | 5.3 | 6.6 |
| Exp. 4 | 1.15 | 1.18 | 8.9 | 7.2 |
| (comparative) | | | | |
| Exp. 5 | 0.91 | 0.94 | 14.5 | 18.2 |
| (comparative) | | | | |

Table 3 illustrates optical density (OD) measurements before washing and after 5 washing cycles with detergent. The prints were printed on an Innovator durability plot (3 dpp ink), using an A3410 pen on pre-treated 100% cotton fabric. Then the prints were cured at 150° C. for 3 minutes. The wash durability was tested after washing five cycles using a conventional washer at 40° C. with detergent.

Optical density or absorbance is a quantitative measure expressed as a logarithmic ratio between the radiation falling upon a material and the radiation transmitted through a material.

$${A}_{λ} = - {log}_{10} \frac{{I}_{1}}{{I}_{0}}$$

where A_{λ} is the absorbance at a certain wavelength of light (λ), I1 is the intensity of the radiation (light) that has passed through the material (transmitted radiation), and I0 is the intensity of the radiation before it passes through the material (incident radiation). The incident radiation may be any suitable white light, for example, day light or artificial white light. The optical density or delta E (ΔE) of an image may be determined using various methods. For example, optical density and/or delta E may be determined using a spectrophotometer. Suitable spectrophotometers are available under the trademark X-rite. The optical density (OD) and LAB (L* for the lightness from black (0) to white (100), a* from green (−) to red (+), and b* from blue (−) to yellow (+)) was measured before and after washing, while the fabric dried by air drying between washes.

The ink formulation for printing image quality and image durability tests was formulated as follows. Inks that were used for this printing examples on pre-treated textiles were formulated based on the following recipe: 6% of an anionic aliphatic polyester-polyurethane dispersion (Impranil® DLN-SD, commercially available from Covestro AG), 6% of glycerol, 0.5% of Crodafos®N-3 Acid commercially available from Witco Corp. (Middlebury, Conn.), 1% of liponic ethylene glycol (LEG-1)), 0.22% of Aticide® B20 commercially available from THOR Group Ltd, 0.3% of Surfynol commercially available from Air Products 440, 3% of cyan pigment dispersion or 2.5% carbon black and balance of water.

Based upon the above discussion and illustrations, those skilled in the art will readily recognize that various modifications and changes may be made to the various examples without strictly following the exemplary examples and applications illustrated and described herein. Such modifications do not depart from the true spirit and scope of various aspects of the disclosure, including aspects set forth in the claims.

What is claimed is:

1. A printable medium, comprising:
a fabric base substrate, with an image-side and a back-side;
a film-forming layer, applied to the image-side of the fabric base substrate, including an anionic polyurethane dispersion having a reactive group on a backbone of the polyurethane dispersion and a reactive group on a capping unit of the polyurethane dispersion; and
an ink-receiving coating layer, applied over the film-forming layer, including a crosslink agent.

2. The printable medium of claim 1, wherein the film-forming layer further includes vinyl-urethane, acrylic urethane, polyurethane-acrylic, polyether polyurethane, polyester polyurethane, polycaprolactam polyurethane, polyether polyurethane, or a combination thereof.

3. The printable medium of claim 1, wherein the film-forming layer includes a stabilization group on the capping unit of the polyurethane dispersion.

4. The printable medium of claim 3, wherein the stabilization group includes a carboxylate functional group, a sulfonate functional group, or a combination thereof.

5. The printable medium of claim 1, wherein the backbone of the anionic polyurethane dispersion further includes a polymerized isocyanate.

6. The printable medium of claim 1, wherein the crosslink agent is a heterocyclic ammonium salt.

7. The printable medium of claim 6, wherein the heterocyclic ammonium salt includes a hydroxyl, carboxyl, acetoxy, alkoxy, amino, or alkyl group at a 3′ position.

8. The printable medium of claim 1, wherein the crosslink agent is a diallylazetidium salt, a bis(2-methoxyethyl)azetidinium salt, a nonylpropylazetidinium salt, a undecylmethylazetidinium salt, or a nonylpropargylazetidinium salt.

9. The printable medium of claim 1, wherein the crosslink agent is an azetidinium salt.

10. A method for forming a printable medium comprising:
providing a fabric base substrate, with an image-side and a back-side;
applying a film-forming layer, on the image-side of the fabric base substrate, the film-forming layer including an anionic polyurethane dispersion having a reactive group on a backbone of the polyurethane dispersion and a reactive group on a capping unit of the polyurethane dispersion; and
applying an ink-receiving coating layer, on the image-side of the fabric base substrate, over the adhesion promoting layer, including a crosslink agent.

11. The method of claim 10, wherein the crosslink agent of the ink-receiving coating layer includes an azetidinium salt, the azetidinium salt formed by reacting an amine terminated polyethylene oxide (PEO) or an amine terminated polypropylene oxide (PPO) with epichlorohydrin.

12. The method of claim 10, further including forming the film-forming layer by reacting a polyol and an isocyanate, the isocyanate selected from the group consisting of: toluene di-isocyanate, 1,6-hexamethylenediisocyanate, diphenylmethanedi-isocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyl-triphenyl-methane-tetra-isocyanate, triphenyl-methane-tri-isocyanate, tris(iso-cyanate-phenyl)thiophosphate, or combinations thereof.

13. The method of claim 10, further including forming the film-forming layer by reacting an isocyanate and a polyol, the polyol selected from the group consisting of: 1,4-butanediol, 1,3-propanediol, 1,2-ethanediol, 1,2-propanediol, 1,6-hexanediol, 2-methyl-1,3-propanediol, 2,2-dimethyl-1,3-propanediol, neopentyl glycol, cyclo-hexane-dimethanol, 1,2,3-propanetriol, 2-ethyl-2-hydroxymethyl-1,3-propanediol, or combinations thereof.

14. A printing method comprising:
obtaining a printable medium comprising:
a fabric base substrate with an image-side and a back-side;
a film-forming layer, applied to the image-side on the fabric base substrate, the film-forming layer including an anionic polyurethane dispersion having a reactive group on a backbone of the polyurethane dispersion and a reactive group on a capping unit of the polyurethane dispersion; and
an ink-receiving coating layer, applied on the image-side, over the film-forming layer, including a crosslink agent; and
applying an ink composition onto the printable medium to form a printed image.

15. The method of claim 14, including applying heat to the printable medium including the ink composition in a range from about 50° C. to about 120° C. for about 5 seconds to about 3 minutes.
